(19) United States
(12) Patent Application Publication
(10) Pub. No.: US 2010/0072663 A1
(43) Pub. Date: Mar. 25, 2010

(54) IN-MOLD-DECORATION METHOD FOR PLASTIC ARTICLES

(75) Inventor: CHUN-YUAN CHANG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/343,496

(22) Filed: Dec. 24, 2008

(30) Foreign Application Priority Data
Sep. 25, 2008 (CN) 200810304665.6

(51) Int. Cl. B29C 45/16

(52) U.S. Cl. 264/255; 264/241

(57) ABSTRACT

A method for producing in-mold-decoration plastic articles includes following steps: providing a mold defining a cavity therein; providing a foil with a plurality of spaced transparent label films attached thereto, each label film having decoration patterns thereon; transporting the foil into the mold, with one of the plurality of label film located in the cavity; injecting molten resin into the cavity of the mold to form a plastic article; unlocking the mold, and separating the label film together with decoration patterns from the foil, therefore allowing the decoration patterns to be adhered to a surface of the plastic article and covered by the label film; transporting portions of the foil without transparent label films out of the mold.

### BACKGROUND

1. Technical Field

The disclosure relates to molding methods and, particularly, to an in-mold-decoration (IMD) method for plastic articles.

2. Description of Related Art

Some plastic articles generally have decorative patterns thereon for aesthetic considerations. Commonly, after the articles are molded, the decorative patterns are merely painted on the surfaces of the plastic articles, however, these decorations are easily worn away over time.

An In-Mold-Label (IML) technology is developed to overcome the above deficiency. IML technology incorporates a transparent foil on which decorative patterns are printed. The foil is placed in a cavity bounded by molds. The decorative patterns adhere to the plastic articles during molding. Although the above method produces longer lasting decorative patterns, a fresh foil must be manually placed in the mold before each molding cycle which increases labor costs and time of production.

The present disclosure provides a mold method to obviate the described limitations.

### BRIEF DESCRIPTION OF THE DRAWINGS

FIG. 1 is a disassembled, cross-sectional view of a first exemplary embodiment of an apparatus for in-mold-decoration of plastic articles.

FIG. 2 is an assembled, cross-sectional view of the apparatus of FIG. 1.

FIG. 3 is similar to FIG. 2, but showing an injection state.

FIG. 4 is a flowchart of a first exemplary embodiment of an in-mold-decoration method for producing plastic articles using the apparatus of FIG. 1.

FIG. 5 is an assembled, cross-sectional view of a second exemplary embodiment of an apparatus for in-mold-decoration plastic articles.

FIG. 6 is a flowchart of a second exemplary embodiment of an in-mold-decoration method for plastic articles using the apparatus of FIG. 5.

### DETAILED DESCRIPTION

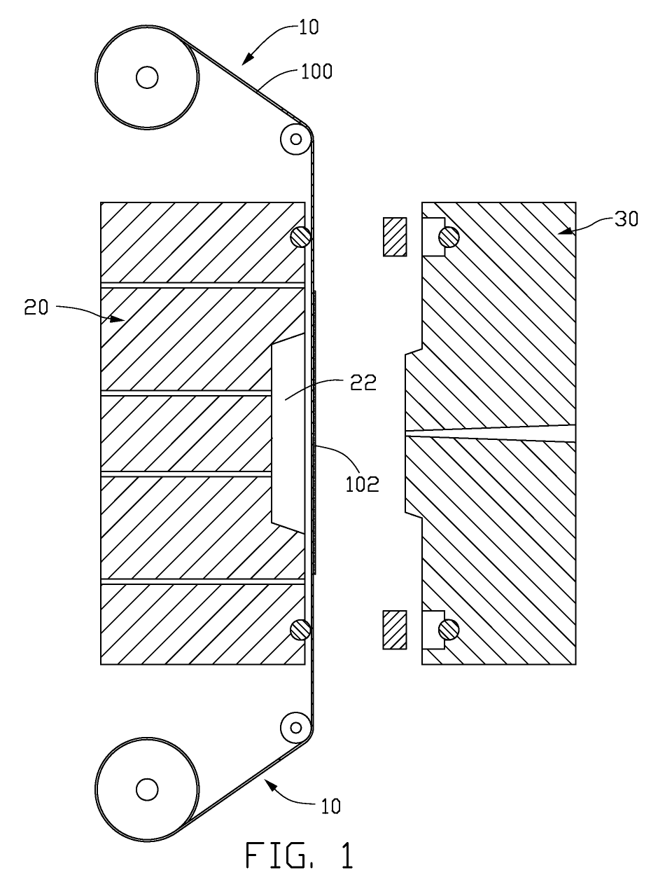

Referring to FIG. 1, an apparatus for in-mold-decoration of plastic articles includes a transport 10, and a mold including a female mold 20 and a male mold 30.

The transport 10 includes two transport rollers and two guiding rollers positioned at two opposite sides of the mold, respectively, for transporting a foil 100 into the mold between the female and male molds 20, 30.

The female mold 20 defines a cavity 22 in a first side thereof facing the male mold 30. The female mold 20 defines a plurality of discharge holes extending from the first side of the female mold 20 to a second side opposite to the male mold 30. At least one of the discharge holes is communicated with the cavity 22. A vacuum-pump (not shown) located at the second side of the female mold 20 is connected to the plurality of discharge holes, for discharging air from the cavity 22.

The male mold 30 includes a projection portion protruding from a first side of the male mold 30 towards the female mold 20, corresponding to the cavity 22. The male mold 30 defines an injection opening extending from the first side through a second side of the male mold 30 opposite to the female mold 20.

In one embodiment, the foil 100 includes a base. A plurality of spaced transparent label films 102 is attached to one side of the base. Decorative patterns are formed on a side of each transparent label film 102 opposite to the base. The decorative patterns include relief patterns, or printed inks. The base of the foil 100 is made of macromolecule material, such as polycarbonate (PC) or polybutylene terephthalate (PBT).

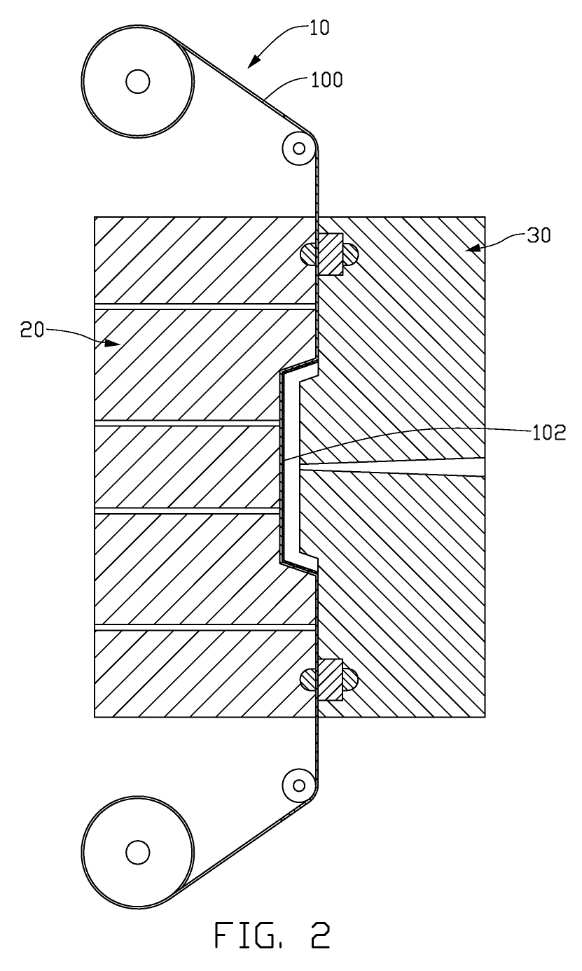

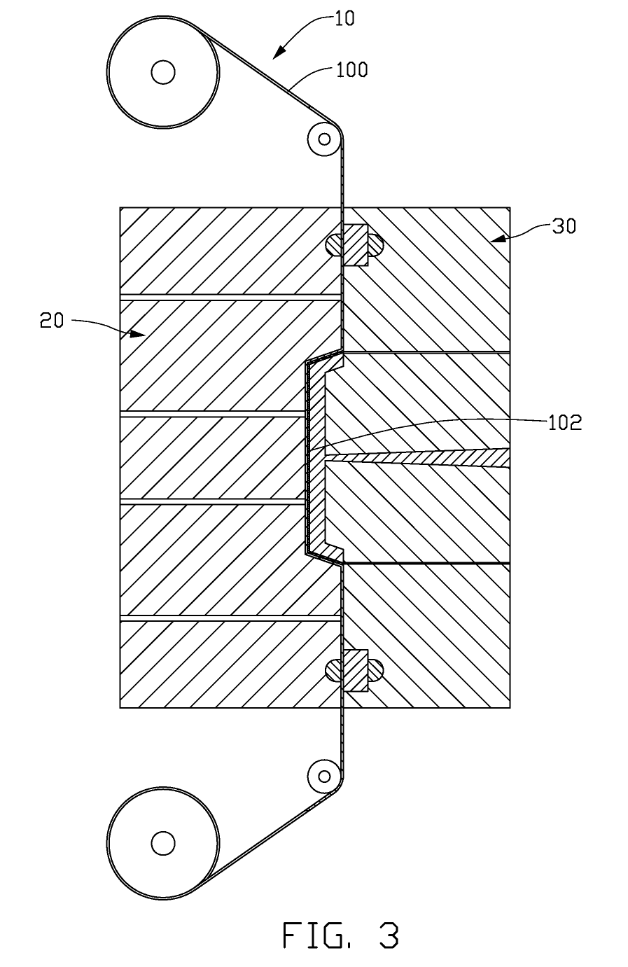

Referring to FIGS. 2 and 3, in use, the transport 10 transports the foil 100 into the mold between the female mold 20 and the male mold 30, with a corresponding transparent label film 102 positioned in a molding space bounded by the foil 100 and the male mold 30. The male mold 30 is clamped to the female mold 20. The vacuum-pump discharges the air from a space bounded by the foil 100 and the inner surface of the cavity 22 through the plurality of discharge holes, making the foil 100 tightly contact the surface bounding the cavity 22. Molten resin is injected into the molding space through the injection opening. The molten resin is cooled to form a plastic product, with the decoration patterns of the transparent label film 102 attached to or integrated on a surface of the plastic product. After the male mold 30 is separated from the female mold 20, the plastic product is ejected from the molding space. The transparent label film 102 with the decorative patterns separates from the base of the foil 100 to be adhered to the plastic. The transport 10 is operated to transport portions of the base without transparent label films 102 to out of the mold, and feed a new portion of transparent label film 102 into the mold for next molding cycle.

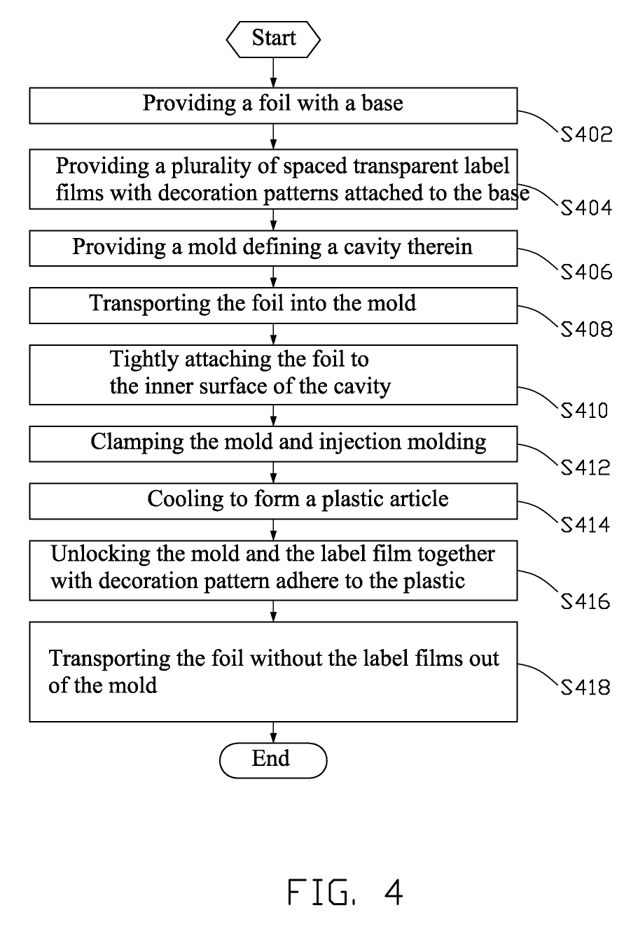

Referring to FIG. 4, a first exemplary embodiment of a method using the first exemplary embodiment of the apparatus for producing IMD plastic articles includes the following steps.

Step 402: providing a foil 100 with a base.

Step 404: providing a plurality of spaced transparent label films 102 attached on the base of the foil 100. Each transparent label film 102 has decoration patterns formed on a side thereof opposite to the base.

Step 406: providing a mold having a female mold 20 and a male mold 30, the female mold 20 defining a cavity 22 therein.

Step 408: transporting the base of the foil 100 with one of the plurality of spaced transparent label films 102 into the mold between the female mold 20 and the male mold 30 by a transport 10.

Step 410: pressing the base of the foil 100 on the female mold 20. Air between the base and the female mold 20 is discharged through a plurality of discharge holes extending through the female mold 20. Therefore, the base tightly contacts the surface bounding the cavity 22.

Step 412: clamping the male mold 30 with the female mold 20 and injecting molten resin into a molding space bounded by the foil 100 and the male mold 30 through an injection opening of the male mold 30.

Step 414: cooling the molten resin in the molding space to form a plastic article.

Step 416: unlocking the mold to separate the male mold 30 from the female mold 20. The plastic article is removed from the mold with the transparent label film 102 adhered to a corresponding surface of the plastic article.

Step 418: the transport 10 moves portions of the base without transparent label films 102 out of the mold.

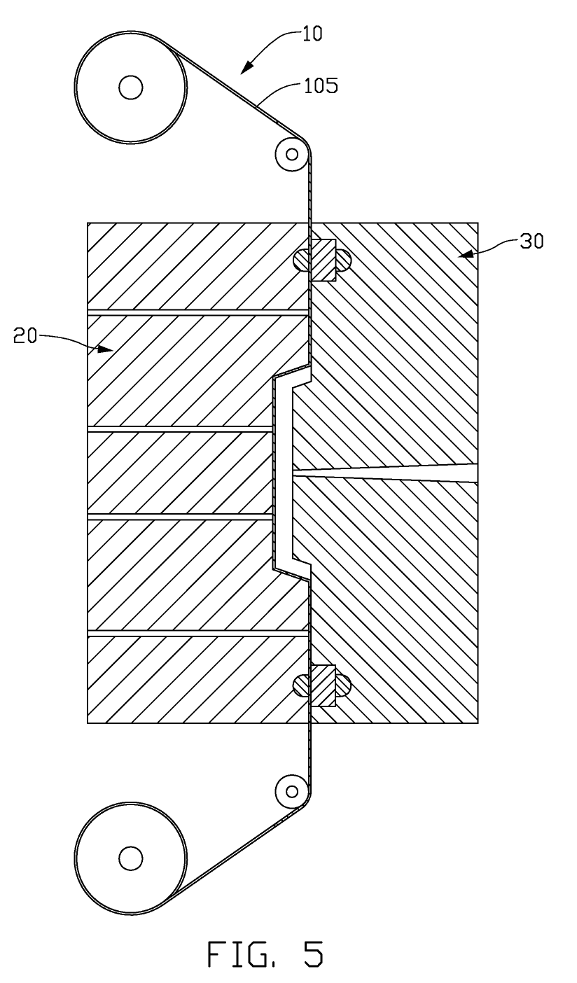

Referring also to FIG. 5, in a second embodiment, a foil 105 is made of transparent materials or partially made of transparent material. Decorative patterns or spaced decorative patterns are directly formed on one side of the foil 105. The transparent material may be macromolecule material, such as PC or PBT. The mold further includes a cutter configured for separate the transparent portion of the base into pieces each with a decoration pattern.

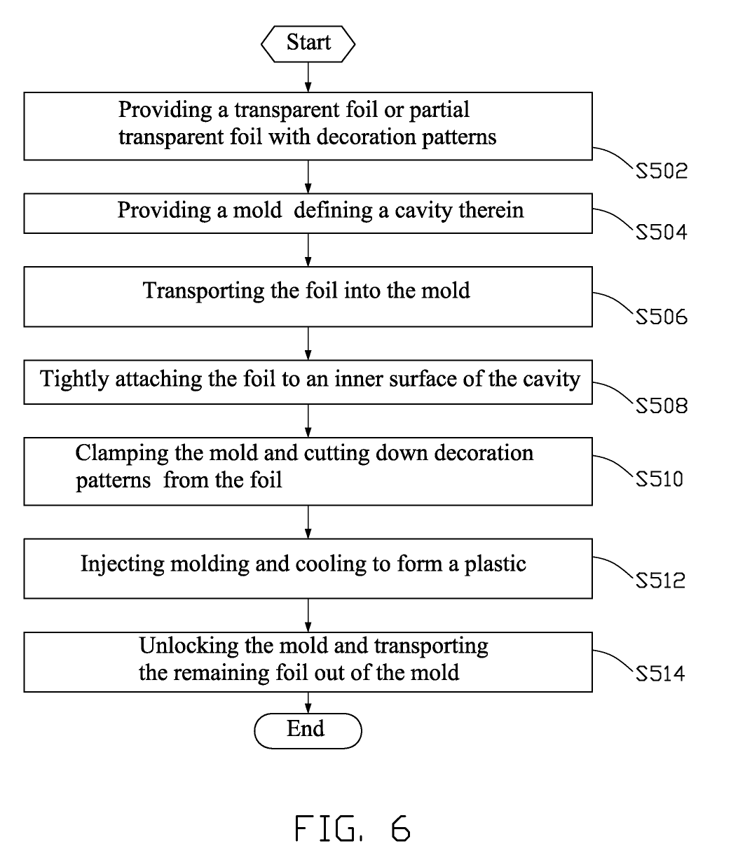

Referring also to FIG. 6, a second exemplary embodiment of a method using the second exemplary embodiment of the apparatus for producing IMD plastic articles includes the following steps.

Step 502: providing a foil 105 made of transparent materials or partially made of transparent materials. A plurality of decoration patterns or a plurality of spaced decoration patterns is formed on the foil 105 or a transparent portion of the foil 105.

Step 504: providing a mold having a female mold 20 and a male mold 30, the female mold 20 defining a cavity 22 therein.

Step 506: transporting the foil 105 into the mold between the female mold 20 and the male mold 30 by a transport 10. One of the decoration patterns is positioned in the cavity 22.

Step 508: pressing the foil 100 on the female mold 20. Air between the foil 105 and the female mold 20 is discharged through a plurality of discharge holes. Therefore, the foil 105 tightly contacts the surface bounding the cavity 22.

Step 510: clamping the male mold 30 with the female mold 20, and cutting one decoration pattern located in the cavity 22 from the foil 105 by a cutter of the mold.

Step 512: injecting molten resin into a molding space bounded by the foil 105 and the male mold 30, and cooling the molten resin to form a plastic product.

Step 514, unlocking the mold to separate the male mold 30 from the female mold 20 and transporting the remaining foil 105 into the mold. The plastic product is removed from the mold with the cut decoration pattern adhering to a corresponding surface of the plastic product and protected by the transparent foil 105.

The methods provide the decoration patterns on the transparent label film 102 attached to the foil 100, or directly provide the decoration patterns on a transparent foil 105 or a partial transparent foil 105, therefore the plastic products are formed with the decoration patterns protected by transparent layers thereon. The decoration patterns are firmly and durably formed on the plastic products.

The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the embodiments described therein.

What is claimed is:

1. A method of in-mold-decoration for plastic articles, comprising:
providing a mold, the mold defining a cavity therein;
providing a foil with a plurality of spaced transparent label films attached thereto, each label film having decoration patterns thereon;
transporting the foil into the mold, with one of the plurality of label film located in the cavity;
injecting molten resin into the cavity of the mold to form a plastic article;
unlocking the mold, and separating the label film together with decoration patterns from the foil, therefore allowing the decoration patterns to be adhered to a surface of the plastic article; and
transporting portions of the foil without transparent label films out of the mold.

2. The method of claim 1, wherein the mold comprises a male mold and a female mold, the cavity is defined in the female mold facing the male mold.

3. The method of claim 2, wherein the step of transporting the foil comprising:
transporting the foil into the mold between the male mold and the female mold;
pressing the foil on the female mold; and
discharging air between the foil and the female mold, for making the foil tightly contact a surface bounding the cavity of the female mold.

4. The method of claim 1, wherein the decoration patterns comprise relief patterns, or printed inks.

5. A method of molding in-mold-decoration for plastic articles, comprising:
providing a mold, the mold defining a cavity therein;
providing a transparent foil with a plurality of decoration patterns formed on the transparent foil, or providing a partial transparent foil having a plurality of transparent portions with a plurality of spaced decoration patterns formed on the transparent portions;
transporting the foil into the mold, with a decoration pattern located in the cavity;
cutting a part of the foil with the decoration pattern located in the cavity from the foil;
injecting molten resin into the cavity of the mold to form a plastic article; and
unlocking the mold, with the decoration pattern adhered to a surface of the plastic article.

6. The method of claim 5, wherein the mold comprises a male mold and a female mold, the cavity is defined in the female mold facing the male mold.

7. The method of claim 6, wherein the transporting the foil step comprises:
transporting the foil into the mold between the male mold and the female mold;
pressing the foil on the female mold; and
discharging air between the foil and the female mold, for making the foil tightly contact an surface bounding the cavity of the female mold.

8. The method of claim 5, wherein the decorative patterns comprise relief patterns, or printed inks.
